(19) United States
(12) Patent Application Publication
(10) Pub. No.: US 2014/0268679 A1
(43) Pub. Date: Sep. 18, 2014

(54) Insect-trapping device

(71) Applicant: Ching Yuan HUANG, Taipei (TW)

(72) Inventor: Ching Yuan HUANG, Taipei (TW)

(21) Appl. No.: 13/845,483

(22) Filed: Mar. 18, 2013

(51) Int. Cl. F21V 33/00; F21L 4/02

(52) U.S. Cl. CPC F21V 33/00; F21L 4/02
USPC 362/101

(57) ABSTRACT

An insect-trapping device includes at least one fluorescent lamp, at least one conductive wire mesh provided on a periphery of the fluorescent lamp and including a cover plate and at least one height adjusting mechanism, a partial translucent body provided between the fluorescent lamp and the conductive wire mesh and surrounding the fluorescent lamp, a power supply device electrically connected to the conductive wire mesh and the fluorescent lamp and including a power and a transformer electrically connected to each other, at least one mercury lamp provided higher than the fluorescent lamp and including at least one height adjusting mechanism, and a sink provided below the conductive wire mesh, wherein a portion of light of the fluorescent lamp is shielded by the partial translucent body and converged within an area surrounded by the partial translucent body.

### FIELD OF THE INVENTION

The present invention relates to an insect-trapping device.

### BACKGROUND OF THE INVENTION

During agricultural production, in order to avoid pests and to further raise crop yields and improve an appearance of the crop for selling, farmers often use a variety of methods and devices preventing and controlling pests and diseases. In general, the purpose of eliminating insects can be achieved by utilizing three ways such as physical, biological, and chemical approaches. The physical approaches utilizes electromagnetic waves, high temperature, light traps, trap collecting method and adhesive method to achieve a goal of getting rid of pests; biological approaches utilizes enemies to pests in the natural environment to suppress excessive breeding of pests; and chemical achieve an effect of eliminating insects in a short period of time approaches by spraying chemical substances such as pesticides and poisonous baits. However, although chemical approaches take a period of short time to reach the purpose of eliminating insects, the long-term impact on the ecological environment should not be underestimated, and it may cause the natural enemies of pests to be killed. In addition to the negative impact on the ecological environment, pests may generate drug-resistance to the drug over time. On the other hand, although adopting light traps, such as mosquito catchers, in the physical approaches causes less impact on the environment, some mosquito catchers utilize light of specific colors generated by specific wavelength to attract mosquitoes. It is really inconvenient for agricultural workers without related equipment.

In view of this, an insect-trapping device is needed, and has advantages of simplicity, convenience, economy, and without pollution. It can take both environmental protection and economic efficiency into account to achieve the purpose of eliminating insects.

### SUMMARY OF THE INVENTION

An aspect of the present invention is to provide an insect-trapping device to solve the above problems encountered by prior art.

An insect-trapping device includes at least one fluorescent lamp, at least one conductive wire mesh, a partial translucent body, a power supply device, at least one mercury lamp, and a sink. The conductive wire mesh is provided on a periphery of the fluorescent lamp and includes a cover plate and at least one height adjusting mechanism. The cover plate is located above the conductive wire mesh to prevent the conductive wire mesh from short circuit or cases of electrical leakages. The height adjusting mechanism makes a height of the conductive wire mesh adjustable. The partial translucent body is provided between the fluorescent lamp and the conductive wire mesh and surrounds the fluorescent lamp. The partial translucent body also has a first spacing distance from the fluorescent lamp and a second spacing distance from the conductive wire mesh, wherein a portion of light of the fluorescent lamp is shielded by the partial translucent body and converged within an area surrounded by the partial translucent body. The power supply device is electrically connected to the conductive wire mesh and the fluorescent lamp, respectively, and includes a power and a transformer electrically connected to each other, wherein the power supply device transforms the power into alternating current to provide electricity to the conductive wire mesh by the transformer. The mercury lamp is provided higher than the fluorescent lamp, and includes at least one height adjusting mechanism so that a height of the mercury lamp is adjustable. The sink is provided below the conductive wire mesh.

The present invention utilizes the configuration of the above structure to complete an insect-trapping device overcoming the problems of the prior art. As a result, this insect-trapping device has functions of light trapping and eliminating insects by drowning and advantages of simplicity, convenience, economy, and without pollution.

### BRIEF DESCRIPTION OF THE DRAWINGS

FIG. 1 is a side view showing the insect-trapping device of an embodiment in accordance with the present invention.

FIG. 2 is a front view showing the insect-trapping device of an embodiment in accordance with the present invention.

FIG. 3 is a cross-sectional view showing the insect-trapping device of the present invention along a line segment A-A in FIG. 1.

FIG. 4 is a cross-sectional view showing the fluorescent lamp and the partial translucent body along the line segment A-A in FIG. 1 of another embodiment in accordance with of the present invention.

FIG. 5 is a cross-sectional view showing the fluorescent lamp and the partial translucent body along the line segment A-A in FIG. 1 of still another embodiment in accordance with of the present invention.

### DETAILED DESCRIPTION OF THE INVENTION

Hereafter, a plurality of embodiments of the present invention will be disclosed with drawings. For the purposes of a clear description, many practical details will together be described below. However, it should be understood that these practical details are not for restricting the present invention. That is to say, in parts of the embodiments of the present invention, these practical details are not necessary. In addition, for the sake of simplifying figures, some conventional structures and elements in figures will be shown in a simple schematic manner.

FIG. 1 is a side view showing the insect-trapping device of an embodiment in accordance with the present invention. FIG. 2 is a front view showing the insect-trapping device of an embodiment in accordance with the present invention. FIG. 3 is a cross-sectional view showing the insect-trapping device of the present invention along a line segment A-A in FIG. 1. As shown in Figures, in the present embodiment, an insect-trapping device 100 includes 5 fluorescent lamps 120, 2 conductive wire mesh 130, a partial translucent body 140, a power supply device 150, 4 mercury lamps 160, and a sink 170. It should be understood that the present invention is not restricted by the amount of elements of the configuration.

As shown in FIG. 1, in the present embodiment, the conductive wire mesh 130 are provided on the periphery of the fluorescent lamps 120 to electrically strike pests contacting with the conductive wire mesh 130, wherein the conductive wire mesh 130 includes cover plates 132 and height adjusting mechanisms 135. The cover plates 132 are located above the conductive wire mesh 130 to prevent the conductive wire mesh 130 from short circuit or cases of electrical leakages. The height adjusting mechanisms 35 make heights of the conductive wire mesh 130 adjustable. The height of the mercury lamp 160 can be flexibly provided depending on the actual needs of the spatial size and the environmental landform for a person of ordinary skill in the art of the present invention. The partial translucent body 140 is provided between the 5 fluorescent lamps 120 and the 2 conductive wire mesh 130 and surrounds the 5 fluorescent lamps. The partial translucent body 140 has a first spacing distance d1 from the fluorescent lamps 120 and a second spacing distance d2 from the conductive wire mesh 130. Specifically, the key of this embodiment is the configuration among the fluorescent lamps 120, the conductive wire mesh 130, and the partial translucent body 140, which will be described in detail below. First, the fluorescent lamps 120 converge light within an area surrounded by the partial translucent body 140 by means of the partial translucent body 140 with a property of light partially transmitting and partially being shielded. Since the lighting effect of the fluorescent lamps 120 can be significantly improved after light ray of the fluorescent lamps 120 is converged, the area surrounded by the partial translucent body 140 can attract pests to approach more effectively by utilizing the phototropism of pests in nature. Second, before pests attach on the surface of the partial translucent body 140, pests will first contact with the conductive wire mesh 130 and be stroke by the conductive wire mesh 130. As a result, the present embodiment can achieve the purpose of trapping insects. Moreover, the fluorescent lamp 120 is not a light source of a special wavelength, therefore not only it is easy to get, but the lighting effect of it is also good, and the configuration such as additional power supply or special optical equipment is not needed.

As shown in FIG. 1, in the present embodiment, the power supply device 150 is electrically connected to the conductive wire mesh 130 and the fluorescent lamps 120, respectively, and includes a power 152 and a transformer 154 electrically connected to each other, wherein the power supply device 150 transforms the power 152 into alternating current to provide electricity to the conductive wire mesh 130 by the transformer 154.

As shown in FIG. 2, the mercury lamps 160 extend an irradiation distance to the external environment by being provided higher than the fluorescent lamps 120, and further expands an area attracting pests to notice the partial translucent body 140 through extending the irradiation distance to the external environment, wherein the mercury lamps 160 includes the height adjusting mechanisms 135 so that heights of the at least mercury lamp is adjustable. The height of the mercury lamp 160 can be flexibly provided depending on actual needs of the spatial size and an environmental landform for a person of ordinary skill in the art of the present invention.

As shown in FIG. 1, the sink 170 is provided below the conductive wire mesh 130 and collects pests being stroke and dropping by water storage. Moreover, the sink 170 has an effect to further drown pests not being stroke to death.

In an embodiment of a different power source 152, for example, the power source 152 may be a generator, a battery, or a storage battery. And, the present invention is not limited to the above examples.

In one embodiment of the present invention, the conductive wire mesh 130 further includes wheels 180 which are provided at the bottom of the height adjusting mechanism 135 of the conductive wire mesh 130, thereby the convenience of the movement of the conductive wire mesh 130 is increased.

In an embodiment of a different partial translucent body 140, for example, the partial translucent body 140 may be objects such as a translucent plate, or a white cloth, etc, which can converge a portion of the light and to maintain a certain degree of brightness on the surface of the objects and can be implemented to attract pests to approach with a different configuration of the appearance and the size of the partial translucent body 140. It should be understood that the present invention is not limited to the above examples.

As shown in FIG. 3, in the present embodiment, the partial translucent body 140 is presented as a shape of a square column after surrounding these 5 fluorescent lamps 120.

FIG. 4 is a cross-sectional view showing the fluorescent lamp 120 and the partial translucent body 140 along the line segment A-A in FIG. 1 of another embodiment in accordance with of the present invention. As shown in Figure, there are 1 fluorescent lamp 120 and 1 partial translucent body 140 in the present embodiment, wherein the partial translucent body 140 is presented as a shape of a circular tube after surrounding the fluorescent lamp 120.

FIG. 5 is a cross-sectional view showing the fluorescent lamp and the partial translucent body along the line segment A-A in FIG. 1 of still another embodiment in accordance with of the present invention. As shown in Figure, there are one fluorescent lamp 120 and one partial translucent body 140 in the present embodiment, wherein the partial translucent body 140 is presented as a shape of a triangular prism after surrounding the fluorescent lamp 120.

It should be understood that the configuration and the quantity of the fluorescent lamp 120 and the partial translucent body 140 in FIGS. 3-5 are only exemplary and not intended to limit the present invention. The configuration and the quantity of the fluorescent lamp 120 and the partial translucent body 140 can be flexibly selected depending on the actual needs of the spatial size and the environmental landform for a person of ordinary skill in the art of the present invention.

The present invention utilizes the configuration of the structure of the above embodiments to overcome the problems of the prior art. To sum up, this insect-trapping device not only take both functions of light trapping and eliminating insects into account, but also has advantages of simplicity, convenience, economy, and without pollution, which can achieve the object of eliminating insects under the premise of environmental protection and economic benefits.

Although the present invention has been disclosed above with embodiments, they do not limit the present invention. People skilled in this art can make various modifications and retouches without departing from the spirit and scope of the invention. Accordingly, the scope protecting by the present invention shall be based on the content defined by the appended claims.

What is claimed is:

1. An insect-trapping device comprising:
at least one fluorescent lamp;
at least one conductive wire mesh provided on a periphery of the fluorescent lamp and comprising a cover plate located above the conductive wire mesh and at least one height adjusting mechanism so that a height of the conductive wire mesh is adjustable;
a partial translucent body, provided between the fluorescent lamp and the conductive wire mesh, surrounding the fluorescent lamp, and having a first spacing distance from the fluorescent lamp and a second spacing distance from the conductive wire mesh, wherein a portion of light of the fluorescent lamp is shielded by the partial translucent body and converged within an area surrounded by the partial translucent body;
a power supply device electrically connected to the conductive wire mesh and the fluorescent lamp, respectively, and comprising a power and a transformer electrically connected to each other, wherein the power supply device transforms the power into alternating current to provide electricity to the conductive wire mesh by the transformer;
at least one mercury lamp provided higher than the fluorescent lamp and comprising at least one height adjusting mechanism so that a height of the mercury lamp is adjustable; and
a sink provided below the conductive wire mesh.

2. An insect-trapping device according to claim 1, wherein the power is an electricity generator.

3. An insect-trapping device according to claim 1, wherein the power is a battery.

4. An insect-trapping device according to claim 1, wherein the power is a storage battery.

5. An insect-trapping device according to claim 1, the conductive wire mesh further comprising:
at least one wheel provided on a bottom portion of the height adjusting mechanism of the conductive wire mesh.

6. An insect-trapping device according to claim 1, wherein the partial translucent body is a translucent plate.

7. An insect-trapping device according to claim 1, wherein the partial translucent body is a white cloth.

8. An insect-trapping device according to claim 1, wherein a shape presented after the partial translucent body surrounding the fluorescent lamp is a square column.

9. An insect-trapping device according to claim 1, wherein a shape presented after the partial translucent body surrounding the fluorescent lamp is a circular tube.

10. An insect-trapping device according to claim 1, wherein a shape presented after the partial translucent body surrounding the fluorescent lamp is a triangular prism.
